(19) United States
(12) Patent Application Publication
(10) Pub. No.: US 2010/0274374 A1
(43) Pub. Date: Oct. 28, 2010

(54) SYSTEM AND PROCESS FOR THE DETAILED DESIGN AND PRODUCTION OF REINFORCEMENT FOR BUILDINGS

(76) Inventor: Apostolos Konstantinidis, Athens (GR)

Correspondence Address: SKOKOS LAW GROUP, LLC, 1100 JORIE BOULEVARD, SUITE 220, OAK BROOK, IL, 60523, US

(21) Appl. No.: 11/993,076

(22) PCT Filed: Jul. 20, 2006
(86) PCT No.: PCT/EP06/64466

§ 371 Date: Dec. 19, 2007

(30) Foreign Application Priority Data
Jul. 28, 2005 (GR) 20050100399

(51) Int. Cl. G05B 19/4097

(52) U.S. Cl. 700/98; 700/160; 700/97

(57) ABSTRACT

The invention refers to a system and method for the creation, modification, storage, exchange and sharing of detailed design and production of reinforcement for buildings. The system and method according to the invention incorporates a data administration system, which offers the user of the invention the ability to create the detailed designs of the reinforcement and to use the reinforcement data for a variety of reasons, such as the calculation of the volume of the material needed, the selection of reinforcement, the control of CNC machines for the production of the reinforcement etc., in an error free process.

### CROSS-REFERENCE TO RELATED APPLICATION

The present application claims priority from Greek application GR 20050100399 filed on Jul. 28, 2005, the content of which is hereby incorporated by reference into this application.

### BRIEF SUMMARY OF THE INVENTION

The invention refers to a system and method for the creation, modification, storage, exchange and sharing of detailed design and production of reinforcement for buildings. The system and method according to the invention incorporates a data administration system, which offers the user of the invention the ability to create the detailed designs of the reinforcement and to use the reinforcement data for a variety of reasons, such as the calculation of the volume of the material needed, the selection of reinforcement, the control of CNC machines for the production of the reinforcement etc., in an error free process. To achieve this effect, the invention includes hardware and software for the digital administration of the complete life cycle of detailed designs of the reinforcement, i.e. from the creation of the designs to the production of the reinforcement. The reinforcement may be steel reinforcement bars for concrete; fiber reinforced plastic (“FRP”); elements; casings or pre-manufactured elements such as columns, beams, slabs, foundations, stairs and elements for anti-seismic protection and energy absorption.

### BACKGROUND OF THE INVENTION

There are three stages in the design of the frame of a building: a) the “preliminary design”, i.e. an initial structural design of the building, which may comprise alternative solutions, b) the “final design” wherein the conceptual design and its relationship to the architectural design are crystallized and c) the “detailed design” which specifies all construction details of the load bearing structural elements, i.e. the building frame, and provides all necessary technical instructions for its implementation.

The existence of a detailed design, that is the creation of plans which represent the construction in detail, is an indication of the importance and detail level of the requirements of the project owner. The inclusion of three-dimensional images contributes to the accurate production of the reinforcement at the cutting and bending plant. It also assists the project engineer to ensure that the design will be implemented according to its specifications.

The creation of detailed designs involves: a) the designer, who may be an engineer, assistant engineer, foreman or technician, b) the building contractor, and c) the manufacturing plant, where the reinforcement is produced. The designer views the project from a technical perspective, namely the selection of the required reinforcement, i.e. the arrangement of the reinforcement, the dimension of the reinforcing elements, and its detailed design. The building contractor is concerned with the required amount of materials, their cost, the completion time of the project, as well as the arrangement of the transport and distribution of the reinforcement. The manufacturing plant is responsible for cutting, arranging and placing on site the reinforcement. The designer, the building contractor and the manufacturing plant are usually three distinct entities. It is also possible that the same entity or person performs two or even all three of these roles.

The detailed design constitutes the most difficult phase of a building design and requires the most experienced and, thus, well-paid technical professionals. According to current practice, when the designer completes the detailed design, he sends it to the building contractor, who places an order for the required reinforcement. The contractor sends the order to manufacturing plants and decides to award the contract to the most favorable bidder. The manufacturing plant that was awarded the project proceeds with the preparation of the reinforcement according to the order. A common difficulty in this process arises from last-minute changes and alterations, which may be requested by any of the three parties involved or others, for example, the project owner. In this case, the amendments are sent to the engineering design office for checking and possible revision the design. Usually, these actions require substantial amount of work and are of urgent nature. As a result, day-to-day workflow and productivity of the design office suffer considerably. A design office of small or large size needs specialized professionals who are hard to find and highly paid. Most importantly, it faces a serious problem when such a hard-to-find professional leaves the firm. Currently, the detailed design, which is carried out either by hand or using computers, consists in the preparation of two-dimensional plan views of each floor, sections and elevation plans all of which are heavily based on symbols and, thus, their creation and their understanding require good knowledge of the symbols used. This factor varies from professional to professional as they depend from his/her educational background, experience and ability. The current practice has several serious disadvantages: the creation of drawings is an error-prone process; each figure of any element, for example plan view, section, elevation, reinforcement schedules, three-dimensional views, is created independently, and thus it requires a considerable amount of work and is a source of inconsistencies; each time that a modification is required, for example an alteration to the position of reinforcement bars or the shape of stirrups, all drawings must be amended, resulting in considerable delays and increased risk of errors; and the description of a detail is usually done in 3-D, which is a laborious and difficult task.

Once the detailed design is ready, the calculation of the total quantity and cost of materials is a laborious and error-prone task. Every modification results re-calculation, possibly from scratch, of the quantity and cost of materials. Further, the order of the reinforcement includes the careful preparation of several tables, drawings and details, which is a bureaucratic and manual process. For the manufacturing plant, the creation of a detailed and reliable offer is time-consuming and costly. The building contractor has difficulties in making the orders, receiving reliable offers from most of the manufacturing plants and evaluating them. After the job has been awarded, the manufacturing plant is based mainly on human resources for the completion of the job: Regardless the level of automation of the machinery, humans must feed the reinforcement cutting and arrangement machines with data. This procedural step results in errors and, consequently, delays and complaints from the customers.

### DETAILED DESCRIPTION OF THE EMBODIMENTS

The object of the invention is a system and method for the design and production of reinforcement of the structural elements of buildings, which is time efficient and reduces the risk of errors.

One essential element of the system according to the invention is the database, which contains all necessary data for the description of the building, the structural elements, such as columns, beams and footings, and the reinforcement. This database is utilized by all parties involved in the detailed design, namely the designer, the building contractor and the manufacturing plant. As these three parties work, in general, in different computers, data retrieval is not performed on the same physical database. Thus, in order to ensure that they all share the same data, replica databases, i.e. “mirror images”, are used, so that the design, order, implementation and production of reinforcement is based on identical data of the building, without risking data integrity and security. The creation of the mirror images is entrusted to a communication protocol for the bidirectional electronic communication among designer contractor-manufacturing plant, which automatically updates the mirror databases, whenever each of the parties updates a field of the database, which is installed to his/her computer. If the three roles, i.e. the designer, contractor and manufacturing plant are performed by one entity using one single computer then they may all work on the same physical database that is installed in it.

The proposed invention combines, for the first time, the exact spatial representation of the structural frame with the exact spatial representation of the reinforcement in one single image. Additionally, the automation and standardization of the reinforcement description reduces the difficulties related to the plethora of data in an order since the reinforcement may consist of several thousands of pieces. The invention may be used for projects of newly constructed buildings, as well as the reinforcement or extension of existing buildings. It may be used for steel reinforcement of concrete as well as for reinforcement elements made of P.

The system and process according to the present invention offers among others the advantages described below. The present invention allows for easy modifications of the structural elements (e.g. a beam) and of the reinforcing elements (e.g. steel bars). It ensures the clarity and consistency of the construction process because the errors due to human factor are minimized The present invention further ensures very fast and unambiguous digital communication among the designer, the contractor and the manufacturing plant. It allows for cost and time savings during the data creation for CNC production machines, e.g. at the reinforcement cutting and bending catalogues. The present invention's advantages include that the invention: guarantees the correctness of the order according to the requirements of the design; may be implemented with existing or new software; allows for the use of “Expert” software that may be used for the calculation of the reinforcement; ensures the correctness of the implementation of the design; facilitates and simplifies the submission of offers by several manufacturing plants; and accelerates the process of offers and reduces drastically their cost.

### Description of Preferred Embodiment

A preferred embodiment of the invention is comprised of three modules: two identical modules, known as module D, that are installed in the computer of the designer and the building contractor and one module that is installed in the computer of the manufacturing plant, module P. Table 1 presents the elements of these modules.

TABLE 1

| | | module P |
|---|---|---|
| module D | module D | module installed |
| module installed | module installed | in the computer of |
| in the computer of | in the computer of | the manufacturing |
| the designer | the contractor | plant |
| input unit | input unit | input unit |
| output unit | output unit | output unit |
| database | database | database |
| communication protocol | communication protocol | communication |
| data processing unit | data processing unit | protocol |
| visualization software | visualization software | data processing unit |
| input software | input software | visualization |
| calculation software | calculation software | software |
| | | unit to command |
| | | CNC |

Modules D and P include a Data Input Unit, a Data Output Unit, a Data Processing Unit, a Database, a Unit for the bi-directional electronic communication and Visualization software.

Data Input Unit: The data input unit is used for entering data related to the description of the building, building materials, price lists for these materials, availability of materials, etc. In the usual case, the data input unit consists of a keyboard and a mouse. Data entry is facilitated by specialized software, such as:
Software for the modification and storage of the structural model of the building.
Software for the modification and storage of available material types and their prices.
Software for the modification, storage and forwarding of electronic orders.
Software for the modification, storage and forwarding of electronic offers.
Software for the description of the structural elements of the building frame, which is discussed in a paragraph that follows, named Input Software.

Data Output Unit: The data output unit may consist of a printer, plotter, computer monitor, or any conventional accessory device in use with a processor to produce an output. The data output unit produces deliverables in various forms such as the following:
Printer reports (e.g. report of structural calculations for submission to the Urban Planning Authority for approval).
Plotter drawings (e.g., architectural drawings, block plans, reinforcement drawings, various types of floor plans etc).
Three-dimensional structural models, which include the frame of the building and its reinforcement.
Three-dimensional architectural models, which include not only the building frame but also its architectural and decorative elements (walls, doors, windows, fencing, furniture, landscaping etc.)
Conventional or stereoscopic digital videos showing virtual walkthroughs of the structural or architectural three-dimensional models.
Estimation of material quantities in digital or printed form.
Reinforcement catalogues and schedules in digital or printed form.
Monetary cost estimates.
Orders of materials in digital or printed form.

Data Processing Unit: The Data Processing Unit may be a CPU, which performs the calculations. The calculations are based on the building model specified by the user, the catalogues of available type of reinforcement and the governing rules and regulations for structural building design and construction. With the aid of reinforcement price lists, this unit may also calculate the cost of production and placement of reinforcement on site.

Database: The Database is the organized collection of data, which describes the geometry of the building, its structural elements and their reinforcement. Such data are stored in the database, which is accessible by the designer, building contractor and manufacturing plant. The database stores all necessary data to represent the logical, linear and architectural model of the building, the static and dynamic analysis results and the elements of the report for submission to the Urban Planning Authority. The database also stores catalogues of reinforcement elements. Each reinforcement element is identified with a unique identifier (ID), which represents its structural details and its position in the building. The designer, the contractor and the manufacturing plant work, in general, in different computers and therefore data retrieval is not performed on the same physical database, but on the database that is included in the module, where each one works. Thus, in order to ensure that they all share the same data, replica databases, i.e. “mirror images”, are used, so that the design, order, implementation and production of reinforcement is based on identical data of the building, without risking data integrity and security. The creation of the mirror images is entrusted to a protocol of bidirectional electronic communication among designer-contractor-manufacturing plant, which automatically updates the mirror databases, whenever each of the parties updates a field of the database, which is installed to his/her computer. A mirror image of the database or the database itself may be held centrally on a server.

Communication protocol. This is a protocol of bidirectional electronic communication among the designer the contractor and the manufacturing plant, which is employed for data synchronization, namely the automatic update of the databases of each module, whenever a field in a database of any module is updated. The protocol dispatches digitally data from one module and automatically updates the database of the other modules, so that the content of the databases of all modules is identical. Thus, replica databases, i.e. “mirror images”, are achieved, so that all parties that work on the building project share identical data.

Communication protocol: This is a software for the bidirectional electronic communication among the designer the contractor and the manufacturing plant, which is employed for data synchronization, namely the automatic update of the databases of each module, whenever a field in a database of any module is updated. This particular communication software dispatches digitally data from one module and automatically updates the database of the other modules, so that the content of the databases of all modules is identical. Thus, replica databases, i.e. “mirror images”, are achieved, so that all parties that work on the building project share identical data.

Visualization software for the visualization of structural elements of the building: The structural elements and their reinforcement are viewed in a virtual three-dimensional environment so that the user (engineer, contractor, reinforcement technician etc.) has full awareness of the structure. In this virtual environment, the user has the ability to navigate in real time through all areas inside the construction, even areas which are difficult to access at the real construction site. With the aid of advanced stereoscopic representations, the user may realize fully the precise placement method of the reinforcement which is displayed at his/her eye level, because this technique enhances the visual separation of the reinforcement in depth and, thus reduces the need for navigation inside the virtual construction. Using these tools, inexperienced engineers and building contractors are able to prepare for visiting the construction site, supervise the reinforcement detailing and placement, and, having in mind ready solutions for the areas where the assembly of the reinforcement may be problematic, instruct correctly the reinforcement workers.

Further, module D, the modules installed in the respective computers of the designer and the contractor, comprise input software and calculation software.

Input software: The present invention includes input software that facilitates the input of the data, which describes the geometry of the building and the location of the structural elements. The software for the description of structural elements of the building assists the user in defining the building model and provides facilities such as tools for the fast and accurate definition of floor plans, easy modification of existing structural elements, ability to check the user actions, detection of possible user errors and subsequent communication of warning messages.

Calculation software: The present invention further includes calculation software that facilitates the calculation of the data. According to the preferred embodiment, the definition of the reinforcement of a building (i.e., number of bars, diameters, shape and length of reinforcing bars, reinforcement material) is performed automatically by the calculation software on the basis of a) appropriate mathematical models and b) artificial intelligence methods which simulate the way that a human engineer works. Thus, the calculation software employs the best practices for placing the reinforcement and, furthermore, ensures that the governing anti-seismic and concrete-related regulations and statutory codes are obeyed. For the calculation of the correct arrangement of the reinforcement in space, the calculation software utilizes a virtual three-dimensional environment and a mathematical software component called Solid Modeler. In this way the system may identify all cases in which a piece of reinforcement cannot be placed because of spatial overlapping, namely because it is obstructed by another reinforcement element. In such a case it either places the pieces of reinforcement in appropriate positions or alters their shape (creating “bottles” or diversions), using rules that a construction supervisor or reinforcement technician would use on the building site, and finally verifies the correctness of their new position. After having the details of all reinforcement of the construction, the system inserts the data into the database, where they are stored.

Module P of the preferred embodiment, i.e. the module installed in the computer of the manufacturing plant, comprise a unit for the creation of commands for the CNC machines:

Unit for the creation of commands for CNC machines: This is software, which produces the commands to instruct appropriate computer numerically controlled (CNC) machines to produce the reinforcement, on the basis of the data describing each piece of reinforcement, without human intervention. The unit may use reinforcement catalogues which are stored in the database.

In a further embodiment of the invention, which is used in case that the designer, the building contractor and the manufacturing plant coincide in a single entity and use one computer, all elements of the system that are described above, are included in one module.

An important feature of the invention is the means for electronic communication among the various software element. For example, there must be electronic communication between the database and the various software elements such as the software to input data, the software for the calculation of the details of structural elements, the software to output the results and the visualization software, and the software which commands the CNC machines. The provision of such means allows for the automatic update of the content of the database.

The present invention is further comprised of the method employing the system described herein. Below are the steps of the method performed by the designer, contractor and manufacturing plant.

Steps for the Designer Using Module D
a) Create the model of the building using the data input unit and the software for the description of structural elements of the building frame, and selection of parameters describing the building and its structural elements;
b) Store the selected parameters of the model in the database;
c) Using the data processing unit and the software for the calculation of construction details of each structural element, process the building model and allow for the automatic production of the required reinforcement and the detailed models of each piece of reinforcement;
d) Overview and inspect the reinforcement using the software for the visualization of structural elements of the building frame, and decide to accept or modify the results; and
e) Store the results in the database and update all mirror databases.

Steps for the Building Contractor Using Module D
a) Retrieve the results from the database. In case there is a central server, the deliverables become available to the contractor immediately after the designer transfers them to the central server;
b) Allow for the production of deliverables from the data output unit. The deliverables include the reinforcement order in digital and printed form;
c) Initiate a request for offers from suppliers; and
d) Select supplier and submit the order. If there is a central server the order may be submitted via that server.

Steps for the manufacturing plant using Module P
a) Create electronic price list using the data input unit;
b) Receive request for offer and the electronic reinforcement data from the building contractor or the central server;
c) Process the order data and compile offer using the data processing unit;
d) Receive deliverables (final offer) from the data output unit;
e) Submit offer and acceptance of awarded job;
f) Create command files containing cutting and bending commands for CNC machines based on the electronic reinforcement data (data processing unit);
g) Send the command files containing cutting and bending commands for CNC machines to output unit.

According to the preferred embodiment of the inventive method, mirror images of the database are automatically updated via a communication protocol, upon entering, deleting or amending any field of the database. Thus all persons working in different computers may share the same data of the building.

Using the Internet and fast Internet connections (e.g., ADSL), the building contractor may send the order electronically in a secure manner to all interested manufacturing plants and the sender may receive electronically the offers of the plants. The plants, after receiving the electronic order, are able to submit their offer electronically using price lists in digital form. That is, upon receipt of the electronic order, the plant creates the offer with no human intervention. This approach eliminates time-consuming procedures for compiling an offer by hand and the errors associated with the transfer of the order details to the offer. The aforementioned steps of the method may be accelerated if the embodiment of the invention includes a central server, which would be responsible for the coordination of the work flow of the ordering process, the availability of the required data (material catalogues for each design, catalogues of available materials and price lists for each supplier, etc.), and the interconnection and digital communication of the parties involved (forwarding and receipt of orders and offers, offer acceptance, supervision of orders and time schedules, etc.).

The system and method described here may be used for the production of building elements such as windows, doors, railing, flooring, and masonry.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for the design and production of reinforcement for buildings, comprising
at least two modules wherein each one of the at least two modules comprises:
a) database for storage of the data describing elements of the building;
b) visualization software for the visualization of content of the database, wherein the visualization software is in electronic communication with the database; and
c) communication protocol, for digitally dispatching data from one module and automatically updating the database of the other modules, so that the content of the databases of all modules is identical;
and where at least one of the at least two modules further comprises:
d) input software for the input of the data of the structural elements of the building wherein the input software is in electronic communication with the database;
e) calculation software for the calculation of construction details of each structural element wherein the calculation software is in electronic communication with the database; and
f) a unit for the creation of commands for CNC reinforcement cutting machines wherein the unit is in electronic communication with the database.

2. System for the design and production of reinforcement for buildings according to claim 1, wherein the visualization software includes software for the virtual representation of reinforcement in two dimensions.

3. System for the design and production of reinforcement for buildings according to claim 1, wherein the visualization software includes software for the virtual representation of reinforcement in three dimensions.

4. System for the design and production of reinforcement for buildings according to claim 1, wherein the visualization software includes software for the stereoscopic visualization of the building, the structural elements and their reinforcement.

5. System for the design and production of reinforcement for buildings according to claim 1, wherein the system comprises table to store the regulations and statutory building codes for structural projects.

6. System for the design and production of reinforcement for buildings, comprising:
a) a database for storage of the data describing i) the geometry of the building, ii) the structural elements of the building, and iii) the details of the structural elements and their reinforcement;
b) input software for the input of the data of the structural elements of the building, wherein the input software is in electronic communication with the database;
c) calculation software for the calculation of construction details of each structural element, wherein the calculation software is in electronic communication with the database;
d) visualization software for the visualization of the content of the database, wherein the visualization software is in electronic communication with the database; and
e) a unit for the creation of commands for CNC reinforcement cutting machines wherein the unit is in electronic communication with the database.

7. System for the design and production of reinforcement for buildings according to claim 6, wherein the visualization software includes software for the virtual representation of reinforcement in two dimensions.

8. System for the design and production of reinforcement for buildings according to claim 6, wherein the visualization software includes software for the virtual representation of reinforcement in three dimensions.

9. System for the design and production of reinforcement for buildings according to claim 6, wherein the visualization software includes software for the stereoscopic visualization of the building, the structural elements and their reinforcement.

10. System for the design and production of reinforcement for buildings according to claim 6, wherein the system comprises table to store the regulations and statutory building codes for structural projects.

11. Method for the design and production of reinforcement for buildings comprising of the following steps:
a) selection of parameters describing the building and its structural elements;
b) storing the selected parameters in a database, where data of the building, its structural elements and the reinforcement are kept;
c) retrieval of the parameters of the building and the structural elements from the said database and calculation of the dimensions of structural elements and their reinforcement;
d) storing the dimensions of the structural elements and their reinforcement to the said database;
e) retrieval of dimensions of the reinforcement from the said database and generation of the electronic commands for CNC machines for the production of the reinforcement of the structural elements.

12. Process for the design and production of reinforcement for buildings according to claim 11, whereby at least a mirror image of the said database is automatically updated via a communication protocol, upon entering, deleting or amending any field of the said database.

13. Process for the design and production of reinforcement for buildings according to claim 11, whereby the reinforcement material is steel.

14. Process for the design and production of reinforcement for buildings according to claim 11, whereby the reinforcement material is made of composite materials.
